(19) United States
(12) Patent Application Publication
(10) Pub. No.: US 2025/0265827 A1
(43) Pub. Date: Aug. 21, 2025

(54) Image Recognition System

(71) Applicant: Hitachi Astemo, Ltd., Hitachinaka-shi, Ibaraki (JP)

(72) Inventors: Akira KITAYAMA, Chiyoda-ku, Tokyo (JP); Goichi ONO, Chiyoda-ku, Tokyo (JP); Hiroaki ITO, Hitachinaki-shi, Ibaraki (JP)

(21) Appl. No.: 18/844,469

(22) PCT Filed: May 9, 2023
(86) PCT No.: PCT/JP2023/017414

§ 371 Date: Apr. 7, 2025

(30) Foreign Application Priority Data
May 27, 2022 (JP) 2022-087111

(51) Int. Cl. G06V 10/776; G06V 10/44

(52) U.S. Cl. CPC G06V 10/776; G06V 10/44

(57) ABSTRACT

An image recognition system according to one aspect of the present invention includes: a discrepancy information extraction unit that receives each of inference results of old and new machine learning models for the same input image, and outputs, when there is a discrepancy area in the two inference results, image information of the discrepancy area in the input image and information indicating presence or absence of detection of a point of interest in the discrepancy area by the new machine learning model; an object presence/absence determination unit that determines whether a point of interest is included in the image information of the discrepancy area and outputs a determination result; and a performance degradation determination unit that determines performance degradation of the new machine learning model compared with the current machine learning model based on the information indicating the presence or absence of detection of a point of interest in the discrepancy area by the new machine learning model and the determination result of the presence or absence of a point of interest in the image information of the discrepancy area.

### TECHNICAL FIELD

The present invention relates to an image recognition system, and particularly to a technique for verifying an updated image recognition algorithm.

### BACKGROUND ART

One of means for image recognition processing using machine learning is a neural network such as a deep neural network (DNN). In such image processing, it is known that recognition accuracy is dramatically improved as compared with a conventional rule-based algorithm, and practical use in various fields has progressed.

For example, in the field of the automobile industry, it is conceivable to contribute to prevention of a serious accident by applying the DNN to peripheral recognition for driving support and automatic driving. As a requirement of a device that processes the DNN, it is required to process an image sent from a camera at a cycle of several tens of milliseconds order at high speed. Therefore, a device equipped with an expensive graphics processing unit (GPU) has been required. However, due to recent weight reduction of an algorithm and progress of a mounting technique for compressing a model, a low-cost device can be selected, and an electronic control unit (ECU) in which the DNN is mounted on a popular car has been put into practical use.

On the other hand, since recognition performance of the DNN changes depending on data used for learning, it is often impossible to grasp a performance change at the time of update as compared with the conventional rule-based algorithm. That is, there may be a case where a certain image that has been recognized by an existing DNN (hereinafter referred to as “old DNN”) cannot be recognized by a new DNN, or vice versa. As a factor of this, it is difficult for a designer to intentionally grasp quantitatively the degree of influence due to a difference in an algorithm, learning data, a parameter (learning rate, number of times of repeat, etc.) at the time of learning, and the like. In peripheral recognition for driving assistance and automatic driving, erroneous detection and overlooking are major problems, but it is necessary to avoid at least performance degradation of the new DNN with respect to the old DNN before updating.

In order to prove that there is no performance degradation, it is common to confirm that there is no problem in actual vehicle traveling after verification using many test images is performed on the new DNN before applying the new DNN to the ECU. In the verification in the actual vehicle traveling environment, images from those of a simple recognition difficulty level to those having a high degree of difficulty unique to an actual environment that is not assumed in the test image are input, and thus, the verification in the actual vehicle traveling environment is regarded as an important position for compensating for omission of verification in the test image. However, since it is necessary to cover an enormous number of verification scenes for verification in a sufficient actual vehicle traveling environment, verification in ultra-long distance public road traveling or in hundreds of kinds of scenes is required. Therefore, there is a problem that enormous verification time and human cost are generated every time the DNN is updated.

As described above, one of techniques for suppressing the cost for verification of the new DNN is the technique described in Patent Literature 1. In order to suppress the verification cost of a learning model of a new version (corresponding to the new DNN), Patent Literature 1 discloses a configuration in which an inference result when data of a site environment is input is compared with a learning model of an old version (corresponding to the old DNN) in an edge server in which the learning model of the new version is implemented.

### CITATION LIST

### Patent Literature

Patent Literature 1: JP 2019-139734 A

### SUMMARY OF INVENTION

### Technical Problem

However, in comparing the inference results of the new DNN and the old DNN, it is necessary to know a correct answer for the input data in order to judge which result is correct. In the technique described in Patent Literature 1, since it is a precondition that a logic that the inference result should be such for the test data is established in advance, validity of the inference results of the old and new DNNs can be evaluated even in an actual machine environment. On the other hand, the technique described in Patent Literature 1 has a problem that validity of an inference result when unknown site data is input cannot be judged as in public road traveling in automatic driving.

In such a case, only a difference between the inference results of the old and new DNNs can be extracted, but it cannot be determined whether the difference is due to performance improvement or performance degradation of the new DNN. For this reason, it is finally necessary to manually distinguish and judge a factor causing the difference, and human cost increases for verification of the new DNN.

In addition, in recent years where driving assistance and automatic driving have been required to have high functionality, a machine learning model using a DNN or the like is often caused to solve a highly difficult task, and it becomes remarkable that a difference before and after update cannot be grasped. For this reason, there is a demand to frequently implement the cycle of verification, correction, and update, but there is a problem that the verification itself is costly as described above.

The present invention has been made to solve such problems, and an object thereof is to provide an image recognition system capable of reducing human cost for verification by automatically realizing verification of a new machine learning model.

### Solution to Problem

In order to solve the above problems, an image recognition system according to one aspect of the present invention includes a discrepancy information extraction unit, an object presence/absence determination unit, and a performance degradation determination unit.

The discrepancy information extraction unit is configured to receive each of inference results of an existing machine learning model and an updated machine learning model for the same input image input from an image sensor, and output, when there is a discrepancy area in which the two inference results are discrepant, image information of the discrepancy area in the input image and information indicating presence or absence of detection of a point of interest in the discrepancy area by the updated machine learning model.

The object presence/absence determination unit is configured to determine whether a point of interest is included in the image information of the discrepancy area in the input image and output a determination result.

The performance degradation determination unit is configured to determine performance degradation of the updated machine learning model compared with the existing machine learning model based on the information indicating the presence or absence of detection of a point of interest in the discrepancy area by the updated machine learning model and the determination result of the presence or absence of a point of interest in the image information of the discrepancy area in the input image.

### Advantageous Effects of Invention

According to at least one aspect of the present invention, verification of an updated machine learning model can be automatically executed in an image recognition system using a machine learning model. Therefore, human cost for verification can be reduced.

Problems, configurations, and effects other than those described above will be clarified by the following description of embodiments.

### BRIEF DESCRIPTION OF DRAWINGS

FIG. 1 is a block diagram illustrating a configuration example of an image recognition device according to a first embodiment of the present invention.

FIG. 2 is a diagram illustrating an example of discrepancy information of an inference result recognized by a discrepancy information extraction unit according to the first embodiment of the present invention.

FIG. 3 is a flowchart illustrating a procedure example of inference result verification processing according to the first embodiment of the present invention.

FIG. 4 is a table illustrating performance verification determination conditions in a performance degradation determination unit according to the first embodiment of the present invention.

FIG. 5 is a block diagram illustrating a configuration example of an inference result verification unit of an image recognition device according to a second embodiment of the present invention.

FIG. 6 is a flowchart illustrating a procedure example of object presence/absence determination processing according to the second embodiment of the present invention.

FIG. 7 is a table illustrating performance verification determination conditions in a performance degradation determination unit according to the second embodiment of the present invention.

FIG. 8 is a block diagram illustrating a configuration example of an inference result verification unit of an image recognition device according to a third embodiment of the present invention.

FIG. 9 is a flowchart illustrating a procedure example of reverification processing of performance degradation by the image recognition device according to the third embodiment of the present invention.

FIG. 10 is a block diagram illustrating a configuration example of an inference result verification unit of an image recognition device according to Modification (1) of the third embodiment of the present invention.

FIG. 11 is a block diagram illustrating a configuration example of an inference result verification unit of an image recognition device according to Modification (2) of the third embodiment of the present invention.

FIG. 12 is a block diagram illustrating a configuration example of an inference result verification unit of an image recognition device according to a fourth embodiment of the present invention.

FIG. 13 is a table illustrating verification determination conditions in a performance degradation determination unit according to the fourth embodiment of the present invention.

FIG. 14 is a block diagram illustrating a configuration example of an image recognition device and a verification and update system according to a fifth embodiment of the present invention.

FIG. 15 is a block diagram illustrating a hardware configuration example of a calculating machine included in the image recognition device and a verification server according to each embodiment of the present invention.

### DESCRIPTION OF EMBODIMENTS

Hereinafter, examples of modes for carrying out the present invention (hereinafter, referred to as “embodiments”) will be described with reference to the accompanying drawings. In the present specification and the accompanying drawings, the same components or components having substantially the same function are denoted by the same reference numerals, and redundant description is omitted. In addition, in a case where there is a plurality of components having the same or similar functions, description may be made by adding different subscripts to the same reference numerals. In addition, in a case where it is not necessary to distinguish the plurality of components, the description may be made by omitting the subscript.

Note that in the following embodiments, an example in which the present invention is applied to an in-vehicle ECU for vehicle control, for example, an advanced driver assistance system (ADAS) or autonomous driving (AD) will be described. However, the present invention is not limited to the in-vehicle ECU for ADAS or AD. In addition, the present invention may be used for update verification of peripheral recognition AI for automatic forklift trucks or automatic guided vehicles (AGVs) applied to distribution warehouses and the like, and construction machines, or may be used for update verification of AI for monitoring cameras and the like. As described above, the present invention is applicable to overall update verification of an information processing algorithm using machine learning such as image processing.

### First Embodiment

### [Configuration of Image Recognition Device]

First, a configuration of an image recognition system according to a first embodiment of the present invention will be described.

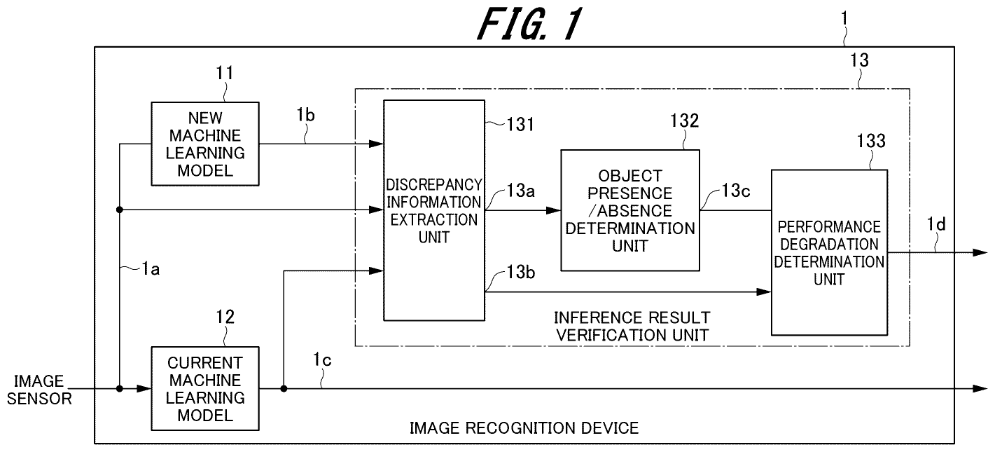

FIG. 1 is a block diagram illustrating a configuration example of an image recognition device (an example of the image recognition system) according to the first embodiment.

The image recognition device 1 includes a first arithmetic unit 12 that executes, as an example of information processing, image processing on input data 1a (an example of an input image) input from an image sensor (an imaging device of an in-vehicle camera) mounted on a vehicle and outputs, as output data, an inference result 1c of a machine learning model. The first arithmetic unit 12 is an arithmetic device including a processor and the like. The first arithmetic unit 12 is assumed to perform large-scale parallel arithmetic using a machine learning model such as a DNN, and a machine learning model that has already been verified to operate normally is implemented in the first arithmetic unit 12. This machine learning model is referred to as a “current machine learning model” for convenience. In FIG. 1, “current machine learning model” is described in the block representing the first arithmetic unit 12. Note that the current machine learning model may be referred to as an “old machine learning model” in comparison with an updated version.

On the other hand, an updated machine learning model updated using additional learning data is considered in order to correct overlooking or a mistake of detection of an object and to additionally recognize a new type of object in the current machine learning model. This machine learning model is referred to as a “new machine learning model” for convenience. Note that the object is an example of a target of interest (hereinafter referred to as a “point of interest”) in the image recognition system of the present invention. The point of interest includes not only an object but also one that can be detected by the image sensor. Examples of the point of interest include a moving object such as a vehicle, a pedestrian, a guardrail, a road sign, a structure such as a building, a traveling line, a hole, light, or a reflection thereof.

In the present embodiment, an inference result of the current machine learning model for the input image of the image sensor is compared with an inference result of the new machine learning model for the input image of the image sensor, and the performance of the new machine learning model is verified using the result. Processing using the new machine learning model is executed by a second arithmetic unit 11, and the second arithmetic unit 11 outputs an inference result 1b of the new machine learning model. The second arithmetic unit 11 is an arithmetic device including a processor and the like. In FIG. 1, “new machine learning model” is described in the block representing the second arithmetic unit 11.

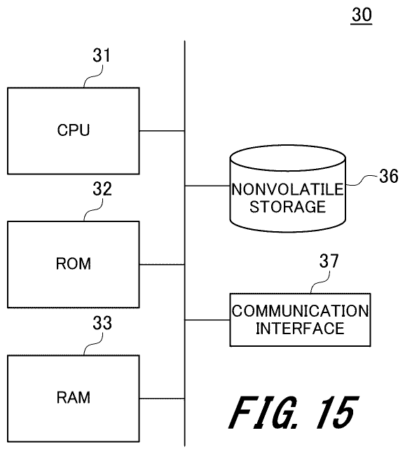

Here, an arithmetic unit that implements the current machine learning model and the new machine learning model is not necessarily divided into the first arithmetic unit 12 and the second arithmetic unit 11. For example, a common arithmetic unit may perform time division processing using the current machine learning model and the new machine learning model, and store the inference results 1b and 1c in a memory (for example, a RAM33 or a nonvolatile storage 36 in FIG. 15 described later).

Next, an inference result verification unit 13 will be described. The inference result verification unit 13 receives the inference result 1c of the current machine learning model, the inference result 1b of the new machine learning model, and the input data 1a from the image sensor, and outputs a performance verification result (a determination result 1d of a performance degradation determination unit 133) of the new machine learning model. The inference result verification unit 13 includes a discrepancy information extraction unit 131, an object presence/absence determination unit 132, and the performance degradation determination unit 133.

The inference result 1c of the current machine learning model, the inference result 1b of the new machine learning model, and the input data 1a from the image sensor are input to the discrepancy information extraction unit 131. Then, the discrepancy information extraction unit 131 outputs discrepancy information 13a, which is information regarding discrepancy between the inference results of the current machine learning model and the new machine learning model for the input data 1a, and presence or absence of detection 13b, which is information indicating the presence or absence of detection of an object (point of interest) in a discrepancy area of the input data 1a (input image) by the new machine learning model. The discrepancy area is an area where the inference results of the old and new machine learning models are discrepant in the input data 1a (input image).

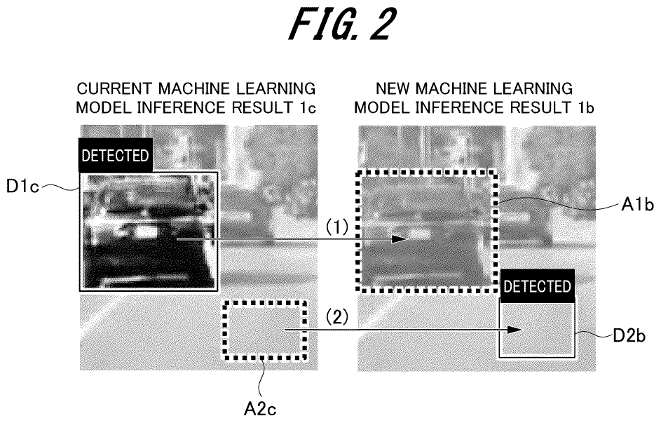

FIG. 2 is a diagram illustrating an example of the discrepancy information 13a of the inference results recognized by the discrepancy information extraction unit 131.

For example, in FIG. 2, a vehicle (object D1c) detected in the inference result 1c of the current machine learning model is not detected (area A1b) in the inference result 1b of the new machine learning model, and these are discrepancy information (Example (1)). In addition, an area (area A2c) on the road that has not been detected by the current machine learning model is detected (object D2b) in the inference result 1b of the new machine learning model, and these are also discrepancy information (Example (2)). For example, the discrepancy information 13a includes coordinates of an object, a class (type of the object), and image information (cut image) of the discrepancy area. The coordinates of the object are coordinates in a coordinate system of the input data 1a (input image).

The object presence/absence determination unit 132 receives the discrepancy information 13a of the inference results, and includes an image discriminator for outputting a determination result 13c regarding the presence or absence of an object in the discrepancy area of the input data 1a (input image). For the image discriminator, a rule-based image processing algorithm may be used, or the image discriminator may be realized by using a convolutional neural network (CNN) or DNN learned in advance to discriminate the presence or absence of an object.

Note that in the discrepancy information 13a, since an image size is different for each scene, an input image size to the object presence/absence determination unit 132 is not constant. In a general DNN, since the input image size is designed to be fixed, it is desirable to have a configuration in which the input image size is set to a fixed image size by performing image resizing processing before the object presence/absence determination unit 132.

The performance degradation determination unit 133 receives the determination result 13c of the presence or absence of an object in the discrepancy area and the presence or absence of detection 13b of an object in the discrepancy area by the new machine learning model, and outputs the determination result 1d (performance verification result) regarding the performance degradation of the new machine learning model.

### [Procedure of Inference Result Verification Processing]

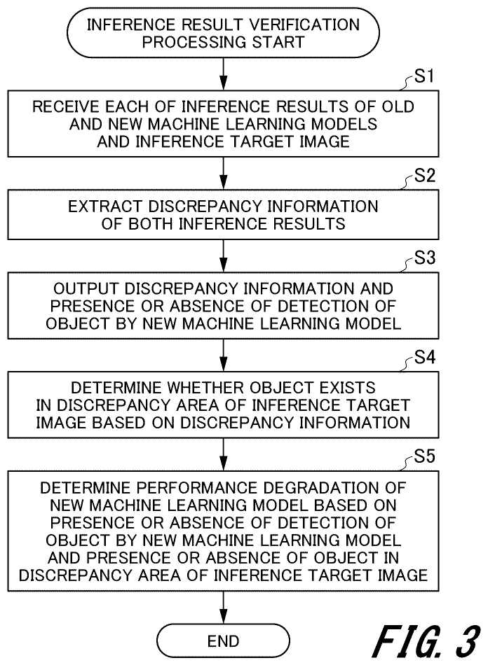

Next, inference result verification processing by the inference result verification unit 13 will be described with reference to FIG. 3.

FIG. 3 is a flowchart illustrating a procedure example of the inference result verification processing by the inference result verification unit 13. In the drawing, the presence or absence of detection 13b of an object in the discrepancy area of the input data 1a (input image) by the new machine learning model is expressed as “presence or absence of detection 13b by new machine learning model”. In addition, the determination result 13c of the presence or absence of an object in the discrepancy area of the input data 1a (input image) is expressed as “object presence/absence determination result 13c”.

First, the discrepancy information extraction unit 131 of the inference result verification unit 13 receives the inference result 1c of the current machine learning model (expressed as “old machine learning model” in the drawing), the inference result 1b of the new machine learning model (updated machine learning model), and an inference target image (input data 1a of the image sensor) (S1).

Next, the discrepancy information extraction unit 131 extracts the discrepancy information 13a of the inference result 1c of the current machine learning model and the inference result 1b of the new machine learning model (S2). At this time, the discrepancy information extraction unit 131 determines whether an object has been detected in the discrepancy area of the inference target image (input data 1a) by the new machine learning model.

Next, the discrepancy information extraction unit 131 outputs the extracted discrepancy information 13a to the object presence/absence determination unit 132, and outputs the presence or absence of detection 13b of an object by the new machine learning model to the performance degradation determination unit 133 (S3).

Next, the object presence/absence determination unit 132 determines whether or not an object exists in the discrepancy area of the inference target image (input data 1a) based on the discrepancy information 13a (including the cut image of the discrepancy area) regarding the inference results 1c and 1b of the current machine learning model and the new machine learning model (S4).

The object presence/absence determination unit 132 outputs the determination result 13c regarding the presence or absence of an object in the discrepancy area of the inference target image (input data 1a) to the performance degradation determination unit 133.

Then, the performance degradation determination unit 133 determines the performance degradation of the new machine learning model based on the determination result 13c of the presence or absence of an object of the inference target image (input data 1a) determined by the object presence/absence determination unit 132 and the presence or absence of detection 13b of an object by the new machine learning model (S5). After the processing of step S5, the inference result verification processing ends.

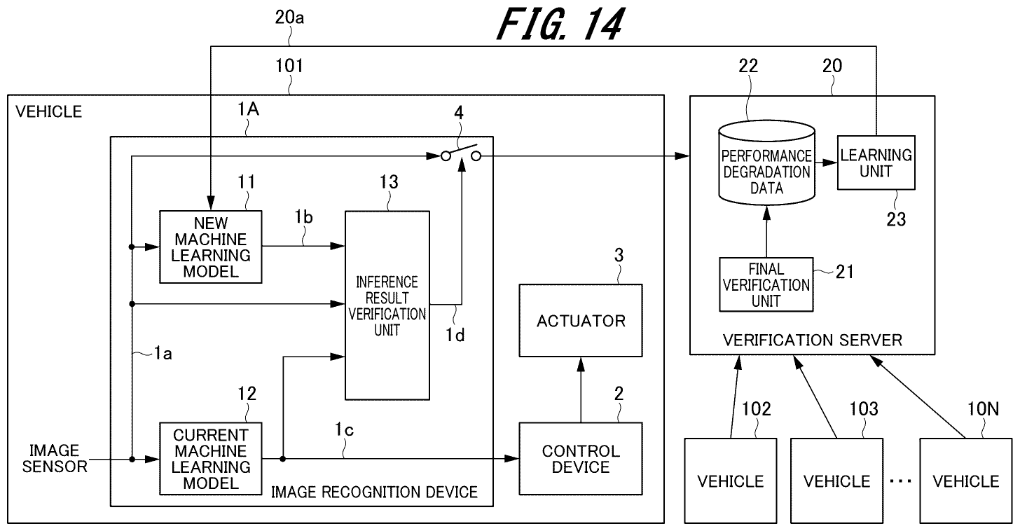

The determination result 1d of the performance degradation determination unit 133 is transmitted to, for example, a verification server 20 as illustrated in FIG. 14 as a performance verification result of the new machine learning model. In addition, the inference result 1c of the current machine learning model is output to a vehicle control ECU (for example, a control device 2 in FIG. 14), which is not illustrated, and the operation of the vehicle is controlled by the vehicle control ECU.

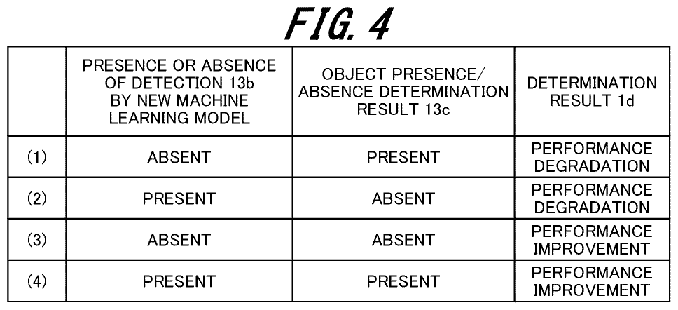

FIG. 4 is a table illustrating performance verification determination conditions in the performance degradation determination unit 133 according to the present embodiment. For example, (1) in the table is a condition similar to Example (1) of the discrepancy information illustrated in FIG. 2. In (1) in the table, the presence or absence of detection 13b of an object by the new machine learning model in the discrepancy area of the input data 1a (input image) is “absent”, and the determination result 13c of the presence or absence of an object in the discrepancy area of the input data 1a is “present”. The object that could have been detected by the current machine learning model cannot be detected by the new machine learning model, and the determination result 1d of the performance degradation determination unit 133 is determined as “performance degradation”. Similarly, in (2) in the table, the presence or absence of detection 13b of an object by the new machine learning model in the discrepancy area is “present”, and the determination result 13c of the presence or absence of an object in the discrepancy area is “absent”. The object that has not been detected by the current machine learning model is detected by the new machine learning model, and the determination result 1d of the performance degradation determination unit 133 is determined as “performance degradation”.

As described above, an image recognition system (image recognition device 1) according to the first embodiment of the present invention includes a discrepancy information extraction unit (discrepancy information extraction unit 131), an object presence/absence determination unit (object presence/absence determination unit 132), and a performance degradation determination unit (performance degradation determination unit 133).

The discrepancy information extraction unit is configured to receive each of inference results of an existing machine learning model (current machine learning model) and an updated machine learning model (new machine learning model) for the same input image (input data 1a) input from an image sensor, and output, when there is a discrepancy area in which the two inference results are discrepant, image information (image information of the discrepancy information 13a) of the discrepancy area in the input image and information (presence or absence of detection 13b of an object by the new machine learning model) indicating the presence or absence of detection of a point of interest in the discrepancy area by the updated machine learning model.

The object presence/absence determination unit is configured to determine whether a point of interest is included in the image information of the discrepancy area in the input image and output a determination result (determination result 13c of the presence or absence of an object in the discrepancy area).

The performance degradation determination unit is configured to determine (determination result 1d) performance degradation of the updated machine learning model compared with the existing machine learning model based on the information (presence or absence of detection 13b) indicating the presence or absence of detection of the point of interest in the discrepancy area by the updated machine learning model and the determination result (determination result 13c) of the presence or absence of the point of interest in the image information of the discrepancy area in the input image.

### Effects of First Embodiment

According to the first embodiment described above, as a configuration in a case where the performance verification of the new machine learning model is performed, the inference result verification unit 13 is disposed in the image recognition device 1, so that the new machine learning model can be verified in a device (for example, an ECU) operating on site. As a result, the number of man-hours of verification work by man is reduced, leading to a reduction in verification cost. In addition, by applying the configuration of the present embodiment to a vehicle of a general user as well as verification with an experimental vehicle owned by a vehicle manufacturer, distributed verification of the new machine learning model can be efficiently performed. For this reason, the verification time is shortened, and the update cost of a machine learning model is reduced.

### Second Embodiment

In the configuration of the first embodiment described above, whether the verification of the new machine learning model can be correctly performed is determined by the determination accuracy of the object presence/absence determination unit 132. As is apparent from FIG. 4, making a mistake in determining the presence or absence of an object in the discrepancy area is the same as mistaking “performance improvement” for “performance degradation”. However, since there is a possibility of occurrence of erroneous determination due to the influence of an unexpected image or noise as long as a phenomenon in the real world is input, it is difficult to realize an image discriminator with a determination accuracy of 100%.

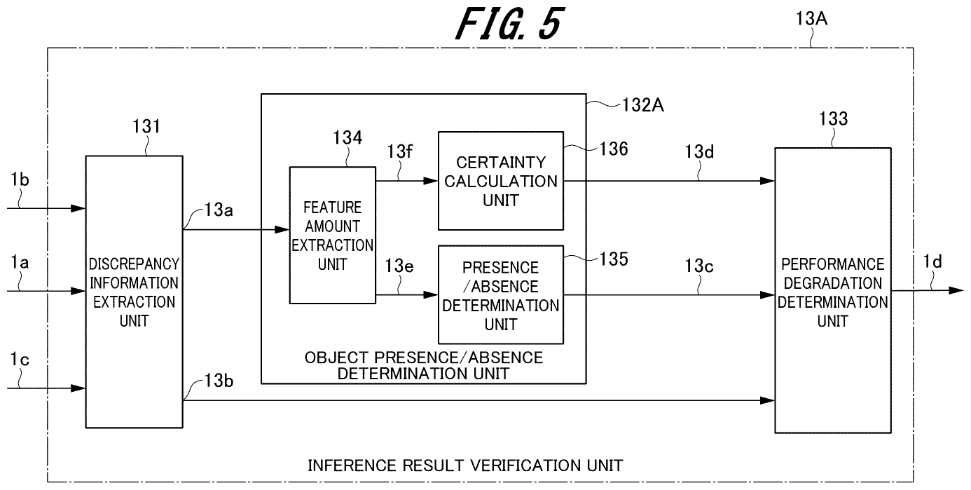

Therefore, in a second embodiment, the “possibility of a determination result” is also included in the output of the object presence/absence determination unit 132 illustrated in FIG. 1. Hereinafter, the probability of the determination result is referred to as “certainty”. As a result, in a case where the certainty of the determination result is low, the current object presence/absence determination unit judges that an image in which it is difficult to distinguish whether the performance is improved or degraded is input, and for example, the image is unconditionally transmitted to a program server, and it is possible to reduce “overlooking of an image to be determined as performance degradation” that should be most avoided at the time of updating the machine learning model. The details will be described below with reference to FIGS. 5 to 7.

### [Configuration of Image Recognition Device]

FIG. 5 is a block diagram illustrating a configuration example of an inference result verification unit 13A of an image recognition device 1 according to the second embodiment of the present invention.

As illustrated in FIG. 5, the inference result verification unit 13A includes a discrepancy information extraction unit 131, an object presence/absence determination unit 132A, and a performance degradation determination unit 133. Then, the object presence/absence determination unit 132A includes a feature amount extraction unit 134, a presence/absence determination unit 135, and a certainty calculation unit 136. The inference result verification unit 13A is greatly different from the inference result verification unit 13 according to the first embodiment in that it includes the certainty calculation unit 136. Note that in the present embodiment, the feature amount extraction unit 134, the feature amount extraction unit 134, and the presence/absence determination unit 135 constitute the image discriminator described above.

The feature amount extraction unit 134 extracts a feature amount of image information (cut image) of a discrepancy area of an input image (input data 1a). The feature amount extraction unit 134 includes a machine learning model (object presence/absence determination model) independent of a current machine learning model and a new machine learning model. For example, in a case where an image discriminator including a general DNN in which one or more fully connected layers are disposed is used, the feature amount extraction unit 134 outputs an image feature amount 13e inferred after passing through all intermediate layers of the DNN to the certainty calculation unit 136. In addition, the feature amount extraction unit 134 outputs an image feature amount 13f inferred after passing through each intermediate layer included in the DNN or the like or after passing through the intermediate layer in a predetermined order to the certainty calculation unit 136.

The presence/absence determination unit 135 outputs a determination result 13c as to whether an object is included in the image information in the discrepancy area based on the feature amount of the discrepancy area of the input image (input data 1a) extracted by the feature amount extraction unit 134. Here, for example, in a case where the image discriminator is a general machine learning model in which one or more fully connected layers are disposed, the presence/absence determination unit 135 is learned in advance so that a final determination result can be output by a calculation result (image feature amount 13e) of the fully connected layers. That is, the presence/absence determination unit 135 makes a determination based on the image feature amount inferred after passing through all the intermediate layers of the DNN. As an example, the presence/absence determination unit 135 determines the presence or absence of an object based on a distance (closeness) between an object-present area (population) including a two-dimensional feature amount and a feature point of the image information in the discrepancy area determined by the two-dimensional feature amount. If this distance is closer than a threshold, the feature point exists in the object-present area, and thus it is determined that “an object is present”, and if this distance is farther than the threshold, it is determined that “an object is absent”.

The certainty calculation unit 136 calculates a certainty 13d of the determination result 13c of the presence or absence of an object in the image information of the discrepancy area by the presence/absence determination unit 135. The determination accuracy of the presence/absence determination unit 135 is affected by the accuracy of the feature amount extracted by the feature amount extraction unit 134. Therefore, the determination accuracy of the presence/absence determination unit 135 can be measured based on the accuracy of the feature amount extracted by the feature amount extraction unit 134. Therefore, in the present embodiment, the certainty of a feature amount extraction result (image feature amount 13f) of the feature amount extraction unit 134 is calculated as the certainty 13d of the determination result of the presence or absence of an object in the image information of the discrepancy area. The object presence/absence determination unit 132A outputs the determination result 13c of the presence or absence of an object in the image information of the discrepancy area and the certainty 13d of the determination result to the performance degradation determination unit 133.

There are various methods for calculating the certainty 13d, and the simplest one may be the degree of confidence that is output simultaneously with the determination result of the DNN. For example, the certainty calculation unit 136 calculates the certainty 13d of the image feature amount based on the degree of confidence of the image feature amount output together with the image feature amount (image feature amount 13f) output from each intermediate layer of the DNN or the intermediate layer in a predetermined order. Alternatively, the certainty calculation unit 136 may be a means of learning to output the uncertainty level (certainty=(1−uncertainty level)) of the inference result of the image feature amount. The output certainty 13d is, for example, a value between 0 to 1, “certainty: high” may be output when the certainty is 0.5 or more, and “certainty: low” may be output when the certainty is less than 0.5. The threshold for judging the level of certainty can be determined by a designer.

Note that the certainty calculation unit 136 may be configured to directly calculate the certainty of the determination result 13c of the presence or absence of an object in the image information of the discrepancy area by the presence/absence determination unit 135 including a DNN or the like.

The performance degradation determination unit 133 receives the determination result 13c of the presence or absence of an object in the discrepancy area, the certainty 13d of the determination result, and the presence or absence of detection 13b of an object by the new machine learning model. When the certainty 13d calculated by the certainty calculation unit 136 is lower than the threshold, the performance degradation determination unit 133 determines that there is performance degradation in the new machine learning model, and outputs a determination result 1d.

### [Object Presence/Absence Determination Processing]

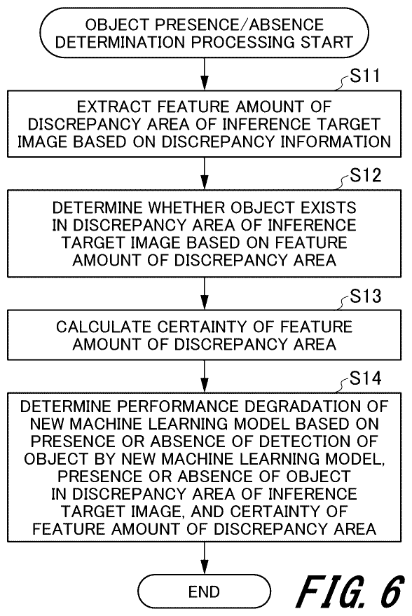

Next, object presence/absence determination processing (corresponding to step S4 in FIG. 3) by the object presence/absence determination unit 132A will be described with reference to FIG. 6.

FIG. 6 is a flowchart illustrating a procedure example of the object presence/absence determination processing by the object presence/absence determination unit 132A.

First, in the object presence/absence determination unit 132A, the feature amount extraction unit 134 extracts the feature amount 13e of a discrepancy area of an inference target image (input data 1a) based on discrepancy information 13a of an inference result 1c of the current machine learning model and an inference result 1b of the new machine learning model (S11).

Next, the presence/absence determination unit 135 determines whether an object exists in the discrepancy area of the inference target image (input data 1a) based on the feature amount 13e of the discrepancy area (S12).

Next, the certainty calculation unit 136 calculates the certainty 13d of the feature amount 13f of the discrepancy area (S13).

Next, the performance degradation determination unit 133 determines the performance degradation of the new machine learning model based on the determination result 13c of the presence or absence of an object of the inference target image (input data 1a) determined by the object presence/absence determination unit 132, the presence or absence of detection 13b of an object by the new machine learning model, and the certainty 13d of the feature amount of the discrepancy area (S14). After the processing of step S14, the object presence/absence determination processing ends.

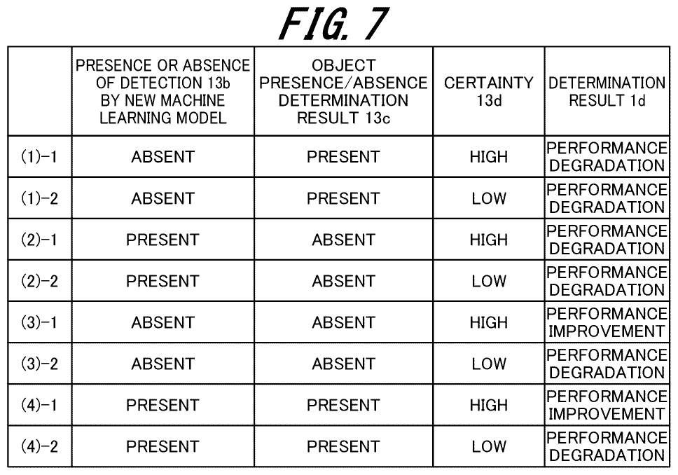

FIG. 7 is a table illustrating performance verification determination conditions in the performance degradation determination unit 133 according to the present embodiment.

Similarly to the first embodiment, (1)-1 and (1)-2 in the table are conditions similar to Example (1) of the discrepancy information illustrated in FIG. 2. In (1)-1 and (1)-2, the presence or absence of detection 13b of an object by the new machine learning model in the discrepancy area of the input data 1a (input image) is “absent”, and the determination result 13c of the presence or absence of an object in the discrepancy area of the input data 1a is “present”. In (1)-1, since the certainty 13d is “high”, the probability of performance degradation is high, and thus the determination result 1d is “performance degradation”. On the other hand, in (1)-2, although the certainty 13d is “low”, the determination result 1d is output as “performance degradation” or “suspected performance degradation”. Note that the “suspected performance degradation” is not illustrated.

In addition, comparing (3)-1 with (3)-2, since the presence or absence of detection 13b of an object by the new machine learning model is “absent” and the determination result 13c of the presence or absence of an object is “absent”, it can be seen that what has been erroneously detected by the current machine learning model is no longer detected by the new machine learning model. Therefore, in (3)-1 where the certainty 13d is “high”, the determination result 1d is “performance improvement”. On the other hand, in (3)-2, since the certainty 13d is “low”, the determination result 1d is output as “performance degradation” or “suspected performance degradation”.

As described above, when the certainty 13d of the determination result 13c of the presence or absence of an object is “low”, the determination result 1d is output as “performance degradation” regardless of the presence or absence of detection 13b of an object by the new machine learning model and the determination result 13c of the presence or absence of an object, whereby overlooking of performance degradation can be reduced.

In addition, if the certainty with respect to the inference result 1c of the current machine learning model or the inference result 1b of the new machine learning model can be calculated, determination including the certainty may be performed. Specifically, when the certainty of the inference result 1b of the new machine learning model is “low” and the presence or absence of detection 13b of an object by the new machine learning model is “absent”, it may be determined as “performance degradation” unconditionally. Alternatively, the certainty of each inference network may be combined and processed as the judgement basis of verification, such as determining as “performance improvement” if the certainty of the determination result of the object presence/absence determination model (presence/absence determination unit 135) is “high” under the same condition.

### Effects of Second Embodiment

According to the second embodiment configured as described above, when the certainty 13d of the determination result 13c of the presence or absence of an object is low, the determination result 1d is output as “performance degradation” regardless of the determination result 13c of the presence or absence of an object. Therefore, it is possible to reduce overlooking of an image (performance degradation scene) to be determined as performance degradation in the new machine learning model.

### Third Embodiment

In the image recognition device 1 according to the second embodiment described above, the cut image (image information of the discrepancy area) having the low certainty 13d of the determination result 13c of the presence or absence of an object in the image information of the discrepancy area is uniformly determined as “performance degradation”. Therefore, even in a case of a scene of originally “performance improvement”, there is a problem that it is determined as “performance degradation” when the certainty is low. That is, over-detection occurs in performance verification.

Therefore, in a third embodiment, in a case where the certainty is determined to be “low”, the determination of the presence or absence of an object in the discrepancy area is performed after performing predetermined preprocessing on the same cut image, whereby the determination result of the presence or absence of an object when the certainty is determined to be “high” is adopted. Here, the predetermined preprocessing refers to image processing such as brightness, contrast, saturation, edge enhancement, and enlargement/reduction (image resizing). For example, in a case where the brightness of the cut image input to the object presence/absence determination unit 132A is low (dark), it is conceivable that the certainty of determination is improved by performing preprocessing for increasing brightness and contrast.

### [Configuration of Image Recognition Device]

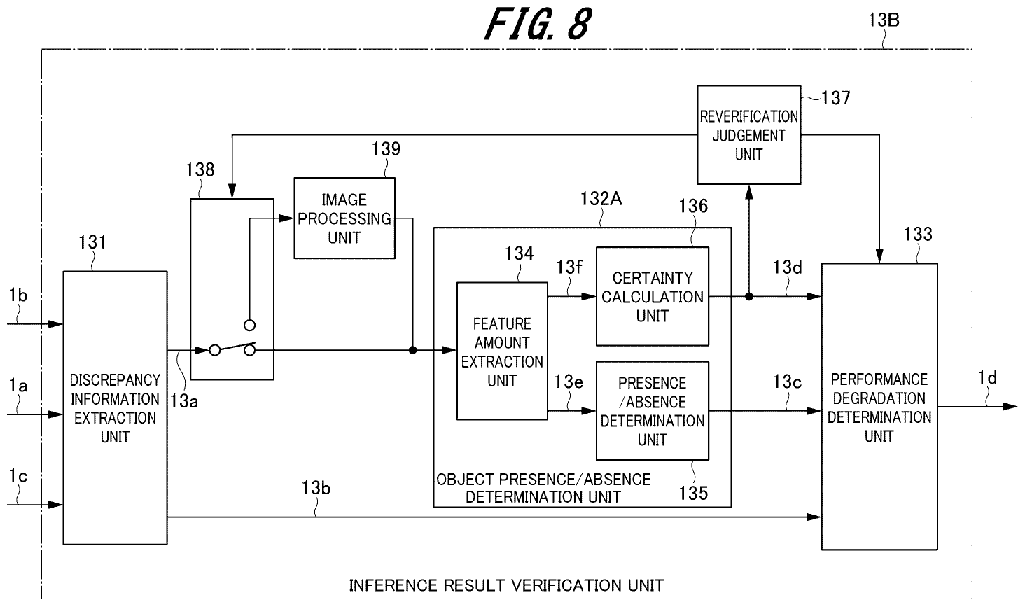

A configuration of an image recognition device according to the third embodiment will be described with reference to FIG. 8.

FIG. 8 is a block diagram illustrating a configuration example of an inference result verification unit 13B of the image recognition device 1 according to the third embodiment of the present invention.

As illustrated in FIG. 8, the inference result verification unit 13B according to the present embodiment further includes a reverification judgement unit 137, a switching circuit unit 138, and an image processing unit 139 in addition to the configuration of the inference result verification unit 13A in the second embodiment.

The reverification judgement unit 137 compares a certainty 13d calculated by the certainty calculation unit 136 with a predetermined threshold, performs predetermined image processing on image information of a discrepancy area in an input image (input data 1a) based on a result of the comparison, and judges whether to redetermine performance degradation of a new machine learning model. When the certainty 13d is lower than the threshold, the reverification judgement unit 137 judges to redetermine the performance degradation of the new machine learning model. Then, the reverification judgement unit 137 performs the predetermined image processing on the image information of the discrepancy area in the input image to generate a reverification trigger signal for reverification, and outputs the reverification trigger signal to the switching circuit unit 138. In addition, the reverification judgement unit 137 outputs the reverification trigger signal to a performance degradation determination unit 133, and instructs the performance degradation determination unit 133 to execute redetermination of the performance degradation of the new machine learning model.

The switching circuit unit 138 switches the state of a switching element according to the presence or absence of the reverification trigger signal. When the switching circuit unit 138 does not receive the reverification trigger signal from the reverification judgement unit 137, discrepancy information 13a including the image information of the discrepancy area is input to the feature amount extraction unit 134. On the other hand, when receiving the reverification trigger signal from the reverification judgement unit 137, the switching circuit unit 138 switches the switching element so that the discrepancy information 13a is input to the image processing unit 139. For example, the switching circuit unit 138 can be configured using a switching element such as a MOSFET.

When receiving the reverification trigger signal from the reverification judgement unit 137, the image processing unit 139 acquires the image information of the discrepancy area included in the discrepancy information 13a of the input image (input data 1a) via the switching circuit unit 138, and performs the image processing as described above on the image information of the discrepancy area. Then, the image processing unit 139 outputs the image information of the discrepancy area subjected to the image processing to the feature amount extraction unit 134.

The feature amount extraction unit 134 extracts a feature amount again from the image information of the discrepancy area subjected to the image processing by the image processing unit 139. Then, the certainty calculation unit 136 calculates the certainty (certainty 13d) of the determination result of the presence or absence of an object in the image information of the discrepancy area based on the feature amount (feature amount 13f) extracted again from the image information of the discrepancy area subjected to the image processing, and outputs the certainty to the performance degradation determination unit 133.

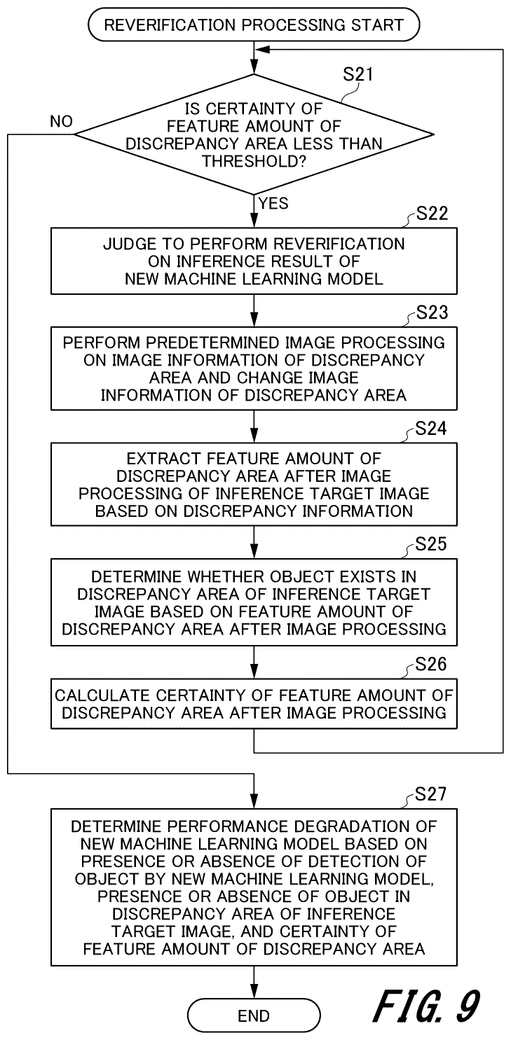

Next, reverification processing of the performance degradation of the new machine learning model by the image recognition device according to the present embodiment will be described with reference to FIG. 9.

FIG. 9 is a flowchart illustrating a procedure example of the reverification processing of the performance degradation of the new machine learning model by the image recognition device according to the present invention.

First, the reverification judgement unit 137 determines whether the certainty 13d of the feature amount of the image information (cut image) of the discrepancy area output from the certainty calculation unit 136 of the inference result verification unit 13B is less than the threshold (S21). When the certainty 13d is equal to or greater than the threshold (NO in S21), the processing proceeds to step S27.

When the certainty 13d is less than the threshold (YES in S21), the reverification judgement unit 137 judges to perform reverification on an inference result 1b of the new machine learning model (S22). Here, the reverification judgement unit 137 outputs the reverification trigger signal to the switching circuit unit 138 and the performance degradation determination unit 133.

Next, the image processing unit 139 performs the predetermined image processing on the image information of the discrepancy area, and changes the image information of the discrepancy area (S23). Thereafter, the processing of steps S24 to 26 is executed. Steps S24 to 26 are the same as steps S11 to S13 of the second embodiment (FIG. 6).

In the object presence/absence determination unit 132A, the feature amount extraction unit 134 extracts a feature amount 13e of the discrepancy area after the image processing of an inference target image (input data 1a) based on discrepancy information 13a of an inference result 1c of a current machine learning model and an inference result 1b of the new machine learning model (S24).

Next, the presence/absence determination unit 135 determines whether an object exists in the discrepancy area of the inference target image (input data 1a) based on the feature amount 13e of the discrepancy area after the image processing (S25).

Next, the certainty calculation unit 136 calculates the certainty 13d of the feature amount 13f of the discrepancy area after the image processing (S26). After the processing of step S26, the processing proceeds to the determination processing of step S21.

Then, in step S21, the reverification judgement unit 137 again determines whether the certainty 13d of the feature amount of the image information (cut image) of the discrepancy area after the image processing is less than the threshold. When the certainty 13d is equal to or greater than the threshold (NO in S21), the processing proceeds to step S27, and when the certainty 13d is less than the threshold (YES in S21), the processing proceeds to step S22.

When the determination is NO in step S21, the performance degradation determination unit 133 determines the performance degradation of the new machine learning model based on a determination result 13c of the presence or absence of an object of the inference target image (input data 1a) determined by the object presence/absence determination unit 132, presence or absence of detection 13b of an object by the new machine learning model, and the certainty 13d of the feature amount of the discrepancy area (S27) as in step S14 in FIG. 6.

After the processing of step S27, the reverification processing of the performance degradation of the new machine learning model ends.

Note that in order to verify the inference result of a new machine learning algorithm using input images sequentially input from an image sensor, the image recognition device described above desirably stops the image processing of the image processing unit 139 at a point in time when a preset condition is satisfied.

For example, in a case where the certainty 13d of the determination result 13c of the presence or absence of an object in the image information of the discrepancy area subjected to the image processing is equal to or greater than the threshold, or in a case where the certainty 13d of the determination result 13c of the presence or absence of an object in the image information of the discrepancy area subjected to the image processing is lower than the threshold but the image processing by the image processing unit 139 has been performed a predetermined number of times, the reverification judgement unit 137 instructs the performance degradation determination unit 133 to execute the determination of the performance degradation of the new machine learning model.

As described above, in a case where the image processing unit 139 performs the image processing (preprocessing) a predetermined number of times, or judges that there is no effect even if the preprocessing is performed more times while observing the change in the certainty 13d with respect to the result of the preprocessing, the preprocessing is terminated, and the determination at the time of the certainty “low” is performed similarly to the second embodiment.

Note that in a case where the number of times of image processing of the image processing unit 139 is the second or later, the image processing unit 139 determines the content of the image processing according to the change in the certainty 13d of the determination result 13c of the presence or absence of an object in the image information of the discrepancy area after the image processing between the previous image processing and the current image processing. The content of the image processing is, for example, the intensity of the image processing or the method of the image processing.

### [Modification (1)]

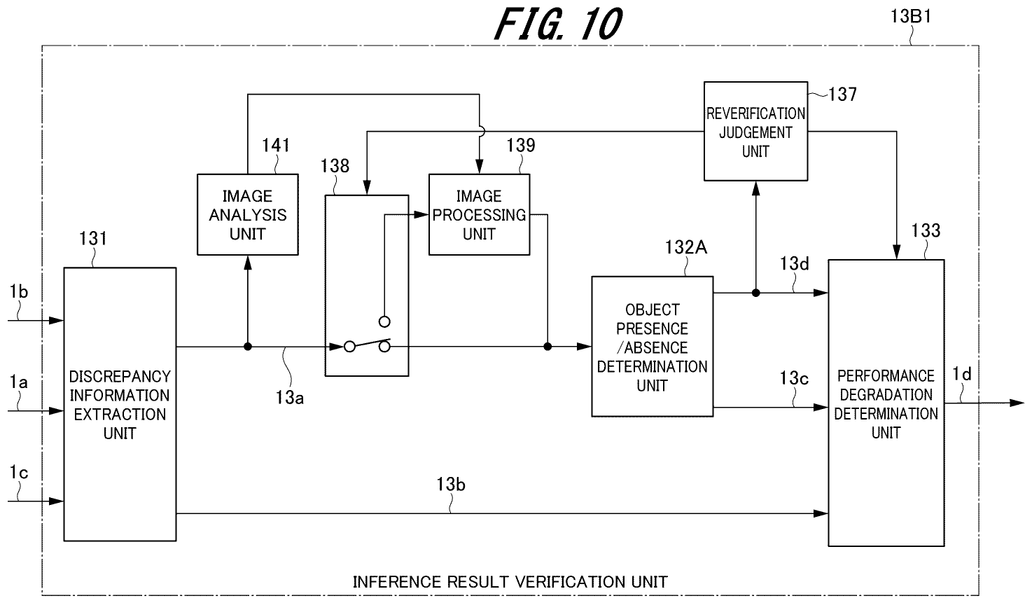

Next, a configuration of an inference result verification unit of an image recognition device according to Modification (1) of the third embodiment of the present invention will be described with reference to FIG. 10.

FIG. 10 is a block diagram illustrating a configuration example of the inference result verification unit 13B1 of the image recognition device according to Modification (1) of the third embodiment of the present invention. The inference result verification unit 13B1 of the image recognition device according to Modification (1) further includes an image analysis unit 141 in addition to the configuration of the inference result verification unit 13B illustrated in FIG. 8.

The image analysis unit 141 analyzes image information of a discrepancy area included in the discrepancy information 13a in the input image (input data 1a), and outputs an analysis result to the image processing unit 139. The image processing unit 139 performs image processing based on the analysis result by the image analysis unit 141.

For example, the image analysis unit 141 analyzes the feature of the input image information (cut image) of the discrepancy area, and the image processing unit 139 performs image processing of lowering brightness in the case of a bright image, image processing of sharpening an edge in the case of a blurred image, and the like. As described above, in the present embodiment, the object presence/absence determination with higher accuracy can be performed by performing the image processing according to the feature of the discrepancy area of the input image.

### [Modification (2)]

In addition, a configuration in which no preprocessing is performed is also conceivable. For example, there is a model ensemble method in which two or more object presence/absence determination models (the object presence/absence determination units 132A) learned under different conditions are arranged in parallel, and a majority decision of determination results of the object presence/absence determination models is taken.

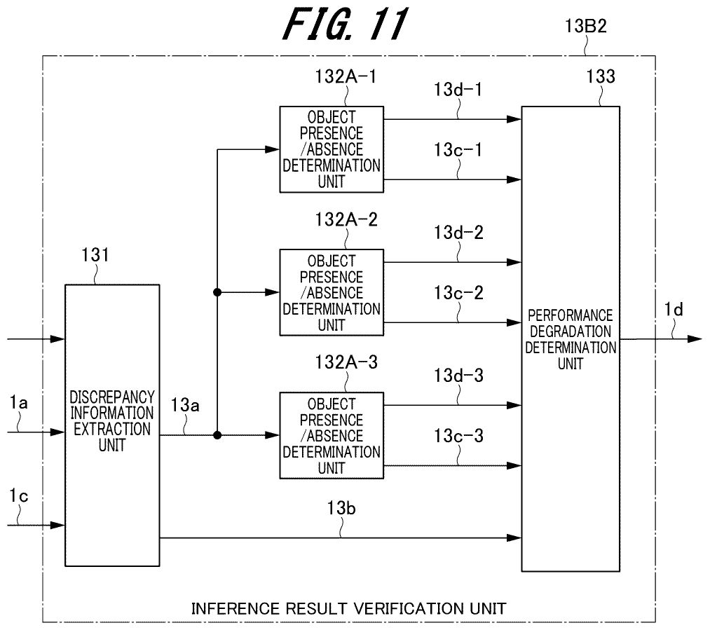

FIG. 11 is a block diagram illustrating a configuration example of an inference result verification unit 13B2 of an image recognition device according to Modification (2) of the third embodiment of the present invention. As compared with the inference result verification unit 13B illustrated in FIG. 8, the inference result verification unit 13B2 of the image recognition device according to Modification (2) is configured to omit the reverification judgement unit 137, the switching circuit unit 138, and the image processing unit 139 and include a plurality of object presence/absence determination units 132A-1 to 132A-3. The number of the object presence/absence determination units 132A may be four or more.

Each of the object presence/absence determination units 132A-1 to 132A-3 includes the feature amount extraction unit 134 (FIG. 8) configured by a machine learning model learned under different conditions. In the object presence/absence determination units 132A-1 to 132A-3, the certainty calculation units 136 have the same configuration, and the presence/absence determination units 135 have the same configuration. The object presence/absence determination units 132A-1 to 132A-3 receive the discrepancy information 13a from the discrepancy information extraction unit 131. Then, the object presence/absence determination units 132A-1 to 132A-3 respectively output, to the performance degradation determination unit 133, determination results 13c-1 to 13c-3 of the presence/absence of a point of interest in the image information of the discrepancy area and certainties 13d-1 to 13d-3 of the determination results.

The performance degradation determination unit 133 determines the final certainty 13d by majority decision from the certainties 13d-1 to 13d-3 of the determination results of the presence or absence of a point of interest in the image information of the discrepancy area output from the object presence/absence determination units 132A-1 to 132A-3. The certainty 13d of the majority is not necessarily the same value, but certainties falling within a preset error range may be regarded as the same certainty (one group), and the certainty may be determined as the final certainty.

Then, the performance degradation determination unit 133 determines performance degradation using the determination result 13c of the presence or absence of an object in the image information of the discrepancy area output from the object presence/absence determination unit 132A that has output the certainty 13d determined by majority decision and the certainty 13d.

When the object presence/absence determination model (in the example, the feature amount extraction unit 134 of the object presence/absence determination unit 132A) is different, the feature amount to be extracted is also different, so that the certainty can be calculated by determination logic such as majority decision.

### Effects of Third Embodiment

In the third embodiment configured as described above, the object presence/absence determination is performed several times while changing an image condition on the image information (cut image) of the discrepancy area with low certainty, so that the probability that overlooking of performance degradation of the new machine learning model can be reduced is increased.

### Fourth Embodiment

In the first to third embodiments described above, performance improvement or degradation is detected by identifying the presence or absence of an object in a cut image (image information of a discrepancy area) of an area that is a difference in object recognition detected by the old and new machine learning models. On the other hand, in a fourth embodiment, in a case where an object is present in the cut image, more detailed verification is realized by verifying an inference result of the type (class) of the object. Examples of the class of the object include, but are not limited to, a vehicle, a motorcycle, a pedestrian, a traffic light, and a signboard.

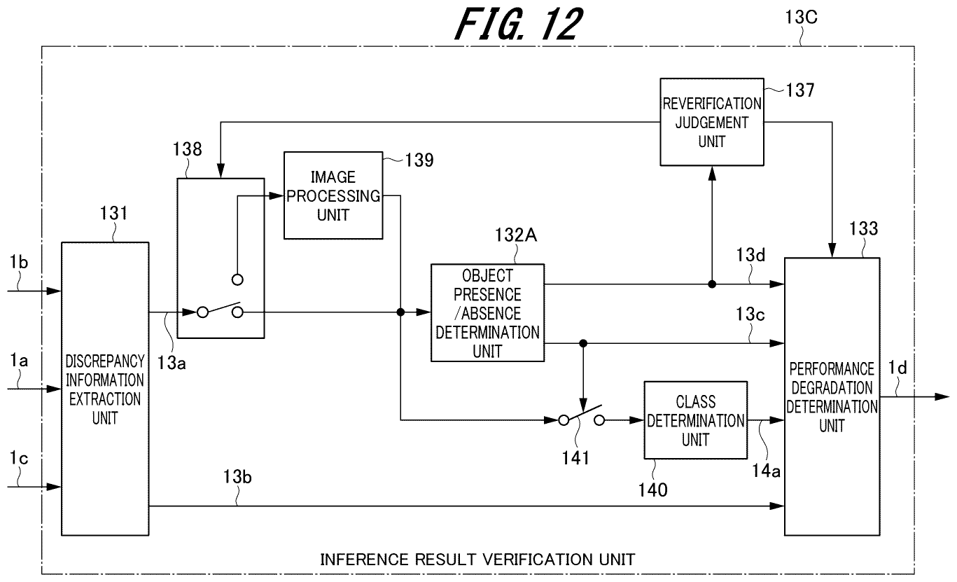

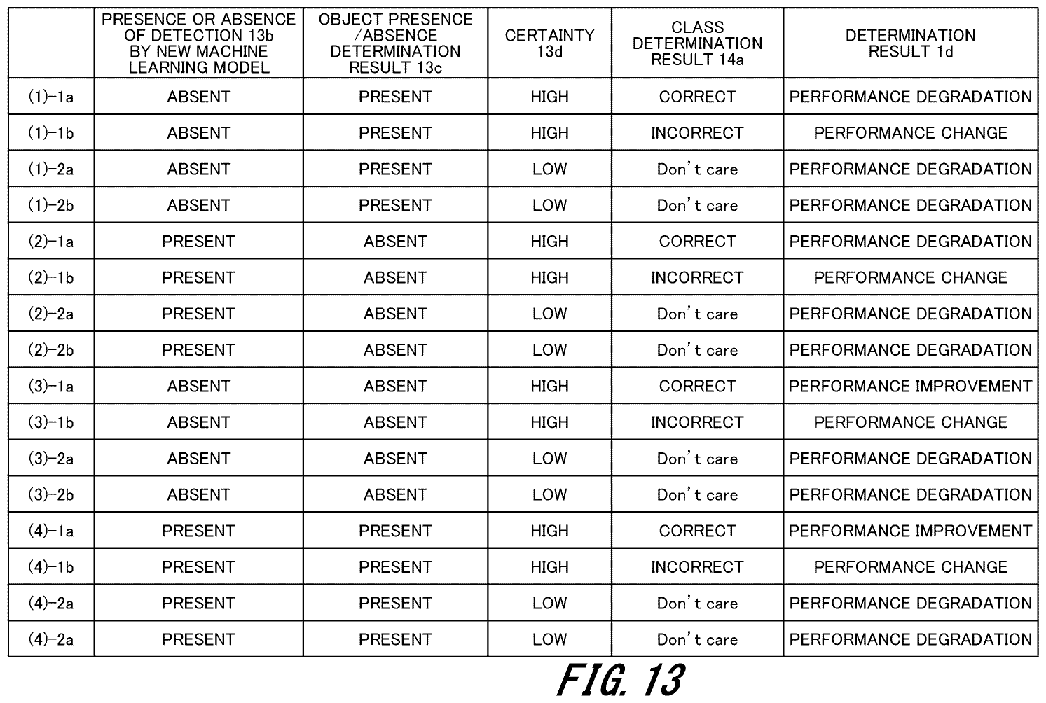

A configuration of an image recognition device according to the fourth embodiment will be described with reference to FIGS. 12 and 13.

FIG. 12 is a block diagram illustrating a configuration example of an inference result verification unit 13C of the image recognition device according to the fourth embodiment of the present invention.

As illustrated in FIG. 12, the inference result verification unit 13C according to the present embodiment further includes a class determination unit 140 and a changeover switch 141 in addition to the configuration of the inference result verification unit 13B in the third embodiment. Configurations other than the class determination unit 140 are applicable to any of the first to third embodiments.

The class determination unit 140 is configured to determine, when the object presence/absence determination unit 132A determines that a point of interest (for example, an object) is included in the image information of the discrepancy area (the determination result of the presence or absence of an object is “present”), the class of the point of interest and output a class determination result (class determination result 14a). When the determination result of the presence or absence of an object is “present”, the changeover switch 141 performs switching such that the discrepancy information 13a is input to the class determination unit 140. Similarly to the switching circuit unit 138, the changeover switch 141 can be configured using a switching element.

A performance degradation determination unit 133 determines the performance degradation of the new machine learning model based on information (presence or absence of detection 13b in the new machine learning model) indicating the presence or absence of detection of a point of interest in the discrepancy area by the new machine learning model, a determination result (determination result 13c of the presence or absence of an object) of the presence or absence of a point of interest in the image information of the discrepancy area in an input image (input data 1a), the certainty (certainty 13d) of the determination result of the presence or absence of the point of interest in the image information of the discrepancy area, and the class determination result (class determination result 14a) of the point of interest. As a result, the performance degradation determination unit 133 can determine which of the performance degradation, the performance improvement, and the performance change of the new machine learning model has occurred.

When the determination result 13c of the presence or absence of an object in the object presence/absence determination unit 132 is “present”, the cut image (image information of the discrepancy area) is input to the class determination unit 140. Similarly to the object presence/absence determination unit 132A, the class determination unit 140 includes a class determination device or the like including a machine learning model. The class determination unit 140 may output only an inference result of class classification (class determination result 14a) or may output also including the certainty of the inference result as in the second embodiment. In a case where the certainty of the inference result is included in the output, the certainty of the inference result (class determination result 14a) of class classification may be input to the reverification judgement unit 137, and it may be determined whether or not to perform reverification together with the certainty (certainty 13d) of the inference result of the object presence/absence determination as in the third embodiment.

FIG. 13 is a table illustrating performance verification determination conditions in the performance degradation determination unit 133 according to the present embodiment.

Similarly to the first embodiment, (1)-1a and -1b and (1)-2a and -2b in the table are conditions similar to Example (1) of the discrepancy information illustrated in FIG. 2. In (1)-1a and -1b and (1)-2a and -2b, the presence or absence of detection 13b of an object by the new machine learning model in the discrepancy area of the input data 1a (input image) is “absent”, and the determination result 13c of the presence or absence of an object in the discrepancy area of the input data 1a is “present”.

The certainty 13d is “high” in (1)-1a and (1)-1b, and the class determination result 14a is “correct” in (1)-1a, but the determination result 1d is “performance degradation”, while the class determination result 14a is “incorrect” in (1)-1b, but the determination result 1d is “performance change”. In addition, since the certainty 13d is “low” in (1)-2a and (1)-2b, the class determination is not performed, and the class determination results 14a are both “Don't care”. Then, any of the determination results 1d is “performance degradation”.

### Effects of Fourth Embodiment

In the configurations of the first to third embodiments, it is possible to verify the performance degradation regarding the presence or absence of an object. However, in the present embodiment, it is possible to perform verification including performance degradation with respect to an inference result of class classification (class determination result 14a), and it is possible to realize the verification of a machine learning model with higher accuracy.

### Fifth Embodiment

Next, a system configuration in which a result verified by a vehicle 101 equipped with the image recognition device configured according to any one of the first to fourth embodiments described above is transmitted to a verification server 20, a machine learning model is relearned after performance degradation data is accumulated, and an updated machine learning model is distributed to the vehicle 101 will be described in the present embodiment.

FIG. 14 is a block diagram illustrating a configuration example of an image recognition device and a verification and update system according to a fifth embodiment of the present invention. In FIG. 14, at least an image sensor, a current machine learning model, and a new machine learning model are implemented in the vehicle 101.

The image recognition device 1A has the configuration of any one of the first to fourth embodiments, and outputs an inference result 1c of the current machine learning model to a control device 2 in a subsequent stage. In FIG. 14, the image recognition device 1A includes a first arithmetic unit 12, a second arithmetic unit 11, an inference result verification unit 13, and a changeover switch 4.

The control device 2 to which the inference result 1c of the current machine learning model is input is assumed to be configured by a control logic for controlling an actuator 3 that controls operation of the vehicle 101.

However, a processing block that performs recognition, acknowledgment, judgement, and the like by a sensor fusion block or the like that integrates recognition results of other sensors may be disposed in a preceding stage.

The image recognition device 1A is further configured to output, by the changeover switch 4, a determination result 1d of degradation determination of the new machine learning model when input data 1a (input image) is input, and output, when a verification result is “performance degradation”, the input data 1a at that time. The input data 1a determined as performance degradation is transmitted to the verification server 20 by wireless communication. However, the data may be temporarily stored in the image recognition device 1A or a storage device in the vehicle 101 before being output and then transmitted to the verification server 20 at a predetermined timing.

The verification server 20 receives the input data 1a (input image) determined as performance degradation among the input data 1a verified in N vehicles including vehicles 101, 102, 103, . . . , and 10N. A final verification unit 21 checks the validity of the determination result 1d of the performance degradation in each vehicle for the received input data 1a. In the final verification unit 21, manual check may be performed, or verification may be performed using a machine learning model higher in performance than the machine learning model implemented in the image recognition device 1A.

Image information (cutout image) of a discrepancy area finally determined as “performance degradation” by the final verification unit 21 is accumulated in a storage device 22. When a verification condition given to each vehicle is satisfied, such as when a predetermined amount of data is accumulated in the storage device 22, when each vehicle achieves a predetermined travel distance, or when each vehicle travels in a predetermined verification scene, relearning of the machine learning model is performed in a learning unit 23 using the performance degradation data accumulated in the storage device 22. The machine learning model after learning is referred to as a “re-updated machine learning model”. The re-updated machine learning model 20a is implemented in a place (arithmetic unit) where the new machine learning model of each vehicle is implemented, and verification is performed according to the operations of the first to fourth embodiments.

### Effects of Fifth Embodiment

According to the fifth embodiment having the above configuration, it is possible to significantly reduce the time and cost of an actual vehicle travel test by verifying the machine learning model in a plurality of vehicles. In addition, in the present embodiment, it is possible to collect images of scenes where recognition performance degrades with respect to the current machine learning model from the plurality of vehicles, and it is possible to more efficiently improve the relearning and performance of the machine learning model. As a result, in the present embodiment, it is possible to provide an image recognition system capable of reducing the time and cost of a series of verification, learning, and update accompanying the machine learning model update.

### Combination of First to Fifth Embodiments

This concludes the description of the image recognition device and the system according to the first to fifth embodiments. Note that the processing of each embodiment may be executed independently, or may be realized by combining at least two of the first to fifth embodiments.

FIG. 15 is a block diagram illustrating a hardware configuration example of a calculating machine included in the image recognition devices 1 and 1A and the verification server 20 according to the embodiments of the present invention. The calculating machine 30 is hardware used as a so-called computer. The calculating machine 30 includes a central processing unit (CPU) 31, a read only memory (ROM) 32, and a random access memory (RAM) 33 each connected to a bus. Furthermore, the calculating machine 30 includes a nonvolatile storage 36 and a communication interface 37 connected to the bus. In FIG. 15, the CPU 31 executes a program stored in the ROM 32 or the nonvolatile storage 36, thereby implementing the functions of the image recognition devices 1 and 1A or the verification server 20 according to the embodiments of the present invention described above.

The calculating machine 30 executes a program by a processor (for example, the CPU 31 or a GPU), and performs processing defined by the program using a storage resource (for example, the RAM 33), an interface device (for example, a communication port), and the like. Therefore, the subject of the processing performed by executing the program may be a processor. Similarly, the subject of the processing performed by executing the program may be a controller, a device, a system, a calculating machine, or a node having a processor. The subject of the processing performed by executing the program may be an arithmetic unit, and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed in the calculating machine 30 from a program source. The program source may be, for example, a program distribution server or a storage medium readable by the calculating machine 30. When the program source is the program distribution server, the program distribution server may include a processor and a storage resource that stores a distribution target program, and the processor of the program distribution server may distribute the distribution target program to another calculating machine. In addition, in an embodiment, two or more programs may be realized as one program, or one program may be realized as two or more programs.

Furthermore, the present invention is not limited to the above-described embodiments, and it is obvious that various other application examples and modifications can be taken without departing from the gist of the present invention described in the claims. For example, the above-described embodiments have been described in detail and specifically in order to describe the present invention in an easy-to-understand manner, and are not necessarily limited to those including all the described components. In addition, it is also possible to add, replace, or omit other components for a part of the configuration of each embodiment. Furthermore, unless otherwise specified, each component may be singular or plural.

Furthermore, in the above-described embodiments, the example of the image recognition processing using the deep neural network as the machine learning has been described, but the present invention is not limited to this example. For example, as machine learning other than the deep neural network, logistic regression, random forest, boosting, support vector machine (SVM), or the like can be used.

Furthermore, in the present specification, the processing order of the processing steps describing the time-series processing may be changed within a range not affecting the processing result.

### REFERENCE SIGNS LIST

1 Image recognition device
11 Second arithmetic unit
12 First arithmetic unit
13 Inference result verification unit
131 Discrepancy information extraction unit
132, 132A Object presence/absence determination unit
133 Performance degradation determination unit
134 Feature amount extraction unit
135 Presence/absence determination output unit
136 Certainty calculation unit
137 Reverification judgement unit
138 Switching circuit unit
139 Image processing unit
140 Class determination unit
20 Verification server
21 Final verification unit
22 Storage device
23 Learning unit
101 to 10N Vehicle

1. An image recognition system comprising:
a discrepancy information extraction unit that receives each of an inference result of an existing machine learning model and an inference result of an updated machine learning model for the same input image output from an image sensor, and outputs, when there is a discrepancy area in which the two inference results are discrepant, image information of the discrepancy area in the input image and information indicating presence or absence of detection of a point of interest in the discrepancy area by the updated machine learning model;
an object presence/absence determination unit that determines whether a point of interest is included in the image information of the discrepancy area in the input image and outputs a determination result; and
a performance degradation determination unit that determines performance degradation of the updated machine learning model compared with the existing machine learning model based on the information indicating the presence or absence of detection of a point of interest in the discrepancy area by the updated machine learning model and the determination result of the presence or absence of a point of interest in the image information of the discrepancy area in the input image.

2. The image recognition system according to claim 1, wherein
the object presence/absence determination unit includes a feature amount extraction unit that extracts a feature amount of the image information of the discrepancy area, and determines whether a point of interest is included in the image information of the discrepancy area based on the feature amount of the image information of the discrepancy area extracted by the feature amount extraction unit.

3. The image recognition system according to claim 2, wherein
the object presence/absence determination unit includes a certainty calculation unit that calculates a certainty of the determination result of the presence or absence of a point of interest in the image information of the discrepancy area, and outputs the determination result of the presence or absence of a point of interest in the image information of the discrepancy area and the certainty, and
when the certainty calculated by the certainty calculation unit is lower than a threshold,
the performance degradation determination unit determines that there is performance degradation in the updated machine learning model.

4. The image recognition system according to claim 3, wherein
the certainty calculation unit calculates, as the certainty of the determination result of the presence or absence of a point of interest in the image information of the discrepancy area, a certainty of a feature amount extraction result of the feature amount extraction unit.

5. The image recognition system according to claim 3, further comprising
a reverification judgement unit that compares the certainty calculated by the certainty calculation unit with the threshold, performs predetermined image processing on the image information of the discrepancy area in the input image based on a result of the comparison, and judges whether to redetermine performance degradation of the updated machine learning model.

6. The image recognition system according to claim 5, further comprising
an image processing unit that performs the predetermined image processing on the image information of the discrepancy area in the input image when the certainty calculated by the certainty calculation unit is lower than the threshold and the reverification judgement unit judges to redetermine the performance degradation of the updated machine learning model, wherein
the feature amount extraction unit extracts a feature amount again from the image information of the discrepancy area subjected to the image processing by the image processing unit, and
the certainty calculation unit calculates the certainty of the determination result of the presence or absence of a point of interest in the image information of the discrepancy area based on the feature amount extracted again from the image information of the discrepancy area subjected to the image processing.

7. The image recognition system according to claim 6, wherein
when the certainty of the determination result of the presence or absence of a point of interest in the image information of the discrepancy area subjected to the image processing is equal to or greater than the threshold, or
when the certainty of the determination result of the presence or absence of a point of interest in the image information of the discrepancy area subjected to the image processing is lower than the threshold, but the image processing by the image processing unit has been performed a predetermined number of times,
the reverification judgement unit instructs the performance degradation determination unit to execute determination of the performance degradation of the updated machine learning model.

8. The image recognition system according to claim 7, wherein
when the number of times of the image processing of the image processing unit is the second or later,
the image processing unit determines content of the image processing according to a change in the certainty of the determination result of the presence or absence of a point of interest in the image information of the discrepancy area subjected to the image processing between previous image processing and current image processing.

9. The image recognition system according to claim 6, further comprising
an image analysis unit that analyzes the image information of the discrepancy area in the input image, wherein
the image processing unit performs the image processing based on an analysis result by the image analysis unit.

10. The image recognition system according to claim 3, further comprising
a plurality of the object presence/absence determination units each including the feature amount extraction unit configured by a machine learning model learned under different conditions, wherein
the performance degradation determination unit determines a final certainty by a majority decision from certainties of determination results of the presence or absence of a point of interest in the image information of the discrepancy area output from the plurality of object presence/absence determination units.

11. The image recognition system according to claim 6, further comprising
a class determination unit that determines, when the object presence/absence determination unit determines that a point of interest is included in the image information of the discrepancy area, a class of the point of interest, wherein
the performance degradation determination unit determines the performance degradation of the updated machine learning model based on the information indicating the presence or absence of detection of a point of interest in the discrepancy area by the updated machine learning model, the determination result of the presence or absence of a point of interest in the image information of the discrepancy area in the input image, the certainty of the determination result of the presence or absence of a point of interest in the image information of the discrepancy area, and a class determination result of the point of interest.

12. The image recognition system according to claim 1, wherein
at least the image sensor, the existing machine learning model, and the updated machine learning model are implemented in a vehicle.
